(19) United States
(12) Patent Application Publication
(10) Pub. No.: US 2008/0301489 A1
(43) Pub. Date: Dec. 4, 2008

(54) MULTI-AGENT HOT-STANDBY SYSTEM AND FAILOVER METHOD FOR THE SAME

(76) Inventors: Shih Ter LI, Taipei City (TW); Yuan-Tsung Hung, Hsinchu City (TW); Jyh-Chyang Yang, Hsinchu (TW)

Correspondence Address: SINORICA, LLC, 528 FALLSGROVE DRIVE, ROCKVILLE, MD, 20850, US

(21) Appl. No.: 11/838,228

(22) Filed: Aug. 14, 2007

(30) Foreign Application Priority Data
Jun. 1, 2007 (TW) 96119692

(51) Int. Cl. G06F 11/14; G06F 11/30; G06F 15/16

(52) U.S. Cl. 714/4; 714/47; 714/E11.179; 714/E11.125

(57) ABSTRACT

The present invention discloses a multi-agent hot-standby system and a failover method for the same, which utilize a plurality of cascaded standby servers to monitor and detect a plurality of application servers, wherein a standby server is parallel connected with all the application servers, and the cascaded standby servers monitor each other. When one application server malfunctions and sends an abnormal heartbeat signal to the standby server directly connected thereto, the standby server immediately replaces the malfunctioning application server. At the same time, another standby server cascaded to the original standby server immediately replaces the original standby server and succeeds to detect and monitor all the application servers. Thereby, the multi-agent hot-standby system and the failover method for the same of the present invention can exempt the programs and tasks executed in application servers from interruption. Further, the present invention can enable a server system to tolerate more faults with less standby servers used.

### BACKGROUND OF THE INVENTION

1. Field of the Invention

The present invention relates to a hot-standby architecture and a failover method thereof, particularly to a multi-agent hot-standby system and a failover method for fault-tolerant systems.

2. Description of the Related Art

More and more critical information applications are processed and stored by powerful computers. Once a computer system malfunctions or has an interruption, an enormous loss will occur. For the organizations needing to guarantee information security or providing non-stop service, how to achieve a high-availability and high-reliability system and maintain the continuous operation of critical applications has become a critical topic. Thus, the fault-tolerant computer application system will be the mainstream in the future.

The current server fault-tolerant technologies for computer application systems include three categories: the single-server fault-tolerant technology, the dual-server hot-standby technology and the load balancing cluster technology. According to different requirements and system designs, the common fault-tolerant technologies can be applied to a same computer system. Refer to FIG. 1 for a conventional large-scale network video system. In the network video system 1, one end has central servers 121, 122 . . . 129 interacting with users 10 via a network; the other end has application servers 161, 162 . . . 169 interacting with front-end devices 181, 182 . . . 189 via a network. The front-end devices 181, 182 . . . 189 include: digital video recorders, video servers, IP (Internet Protocol) cameras, I/O controllers, access controllers, etc. The central servers 121, 122 . . . 129 and the dispatching servers 141, 142 . . . 149 may adopt the load balancing cluster technology or the dual-server hot-standby technology to provide services for users. When users 10 request services from the system, the system actively dispatches the service tasks to corresponding central servers 121, 122 . . . 129 and dispatching servers 141, 142 . . . 149. It is unnecessary to beforehand assign relationships between users 10 and the central servers 121, 122 . . . 129/dispatching servers 141, 142 . . . 149. Contrarily, the relationships between the front-end devices 181, 182 . . . 189 and the application servers 161, 162 . . . 169 are relatively fixed after setting up. In other words, when the application servers 161, 162 . . . 169 receive video information or alarms from the front-end devices 181, 182 . . . 189 or adjust/control the front-end devices 181, 182 . . . 189, realtime response and time continuity is usually required; therefore, it is not appropriate to floatingly assign the relationships between the front-end devices 181, 182 . . . 189 and the application servers 161, 162 . . . 169. Thus, it is inappropriate for the application servers 161, 162 . . . 169 to operate in the load balancing cluster mode. For the network service system having two ends interacting with exterior environments, in the end facing users 10, the relationships between the users 10 and the application servers 161, 162 . . . 169 can be floatingly assigned; in the other end connecting with the front-end devices 181, 182 . . . 189, the active/standby dual-server hot-standby technology is better than the active/active dual-server hot-standby technology or the load balancing cluster technology, considering the requirements of realtime response and time continuity. For example, in the conventional technology shown in FIG. 1, the application servers 161, 162 . . . 169 respectively connect to their own standby servers 171, 172 . . . 179.

As the single-server fault-tolerant technology needs an expensive special high-availability non-stop server, such a technology is unfavorable to the system construction cost. Besides, more standby servers are needed to promote the fault-tolerant capacity.

Accordingly, the present invention proposes a multi-agent hot-standby system and a failover method for the same to overcome the conventional problems mentioned above.

### SUMMARY OF THE INVENTION

The primary objective of the present invention is to provide a multi-agent hot-standby system and a failover method for the same, which applies to monitor a server system.

Another objective of the present invention is to provide a multi-agent hot-standby system and a failover method for the same, which detect heartbeat signals to determine whether monitored servers are normal. If one of the monitored servers is abnormal, a standby server succeeds to execute the programs originally executed by the abnormal server.

To achieve the abovementioned objectives, the present invention proposes a multi-agent hot-standby system. The system of the present invention comprises a plurality of application servers and a plurality of standby servers, wherein the standby servers include at least one first standby server and at least one second standby server; the first standby server connects in parallel with all the application servers, and the first standby server connects in series with the second standby servers. Once the first standby server detects that one of the application servers malfunctions, it replaces the malfunctioning application server. The programs originally executed in the malfunctioning application server are thus transferred to the first standby server and keep on being normally executed in the first standby server without interruption. The second standby server takes over the role originally played by the first standby server and monitors all the application servers. Besides, the repaired application server can be used latter as a second standby server.

The present invention also proposes a failover method for the multi-agent hot-standby system mentioned above. The method of the present invention comprises the following steps: firstly, the first standby server detecting at least one abnormal heartbeat signal; next, finding out the malfunctioning application server according to the path of the abnormal heartbeat signal; next, the first standby server completely replacing the malfunctioning application server; finally, instructing the second standby server to replace the first standby server and monitor all the application servers.

The multi-agent hot-standby system and the failover method for the same of the present invention utilize cascaded standby servers to monitor application servers; therefore, the entire server system can maintain realtime response and time continuity and may have a higher fault-tolerant capacity.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram showing a conventional large-scale network video system;

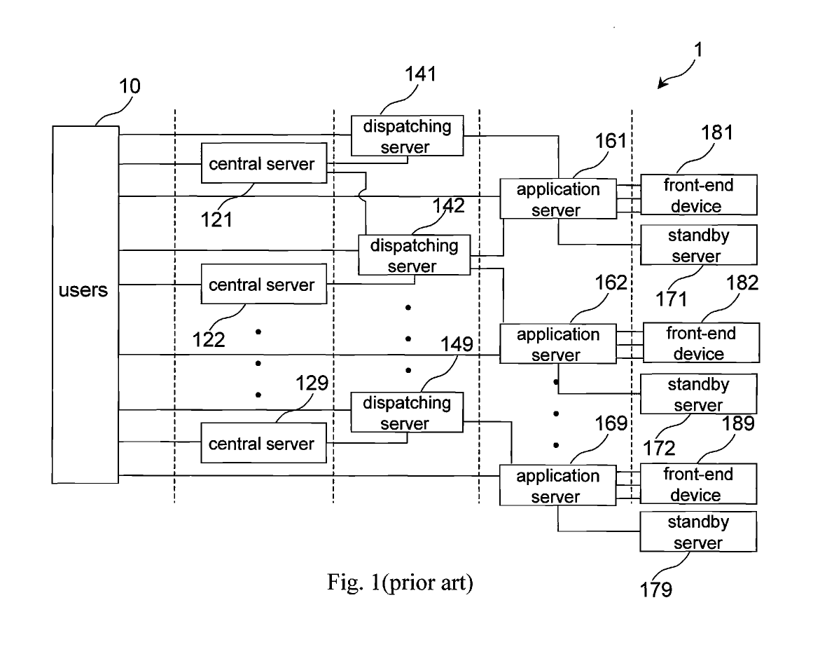

FIG. 2 is a diagram schematically showing the architecture of a multi-agent hot-standby system according to the present invention;

FIG. 3 is a flowchart of the failover method for the multi-agent hot-standby system according to the present invention; and

FIG. 4 is a diagram schematically showing the architecture of a large-scale network video system adopting the multi-agent hot-standby system according to the present invention.

### DETAILED DESCRIPTION OF THE INVENTION

The present invention proposes a multi-agent hot-standby system and a failover method for the same to effectively control the system construction cost and maintain the fault-tolerant capability in the case that a network system cannot adopt a load balancing cluster mode or an active/active mode. Below, the embodiments of the present invention are described in detail in cooperation with the drawings.

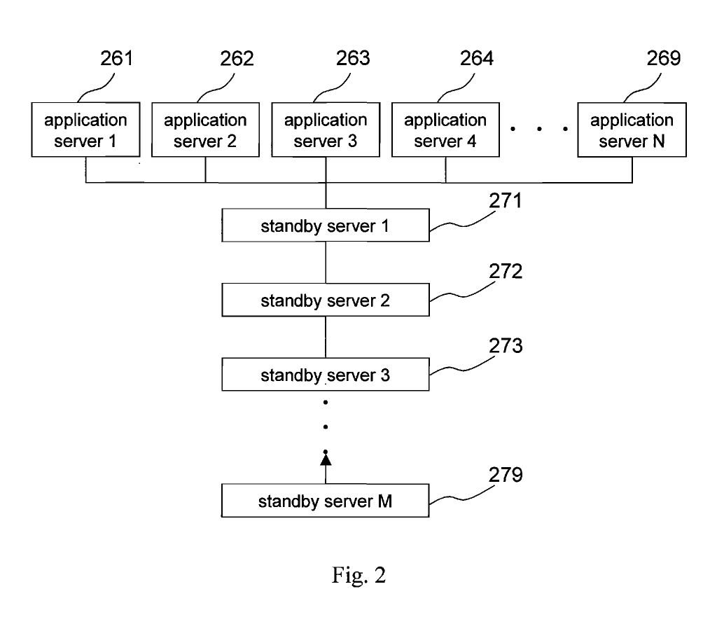

Refer to FIG. 2 a diagram schematically showing the architecture of a multi-agent hot-standby system according to the present invention. In this embodiment, N application servers 261, 262, 263, 264 . . . 269 respectively execute programs thereinside, and each of the application servers 261, 262, 263, 264 . . . 269 at a given timing generates a heartbeat signal functioning as a communication signal. For reducing interference during heartbeat signal transmission, each of the application servers 261, 262, 263, 264 . . . 269 may have dual-network equipment to establish a dedicated subnet mask for hart-beating signals. A first standby server 271 is parallel connected to the N application servers 261, 262, 263, 264 . . . 269 and simultaneously receives the heartbeat signals of the N application servers 261, 262, 263, 264 . . . 269 for monitoring and detecting them. At least one second standby server 272, 273 . . . 279 is connected in series to the first standby server 271. While the first standby server 271 is monitoring the application servers 261, 262, 263, 264 . . . 269, the second standby server 272 is also monitoring and detecting the first standby server 271 coupled thereto via receiving the heartbeat signals of the first standby server 271.

According to the system architecture shown in FIG. 2, the operational process is described below. When the first standby server 271 detects an abnormality of the second application server 262 (For example, the second application server 262 generates an incorrect heartbeat signal or no more generates any heartbeat signal), the programs and tasks executed by the second application server 262 are instantly transferred to and executed by the first standby server 271. Simultaneously, as the second standby server 272 cascaded to the first standby server 271 does not receives any heartbeat signal from the first standby server 271, the second standby server 272 immediately replaces the first standby server 271 and connects with the first application server 261, the third application server 263, the fourth application server 264 . . . the Nth application server and the first standby server 271, which has replaced the second application server 262. At the same time, another second standby server 273, which is cascaded to the second standby server 272, takes over the task of the second standby server 272.

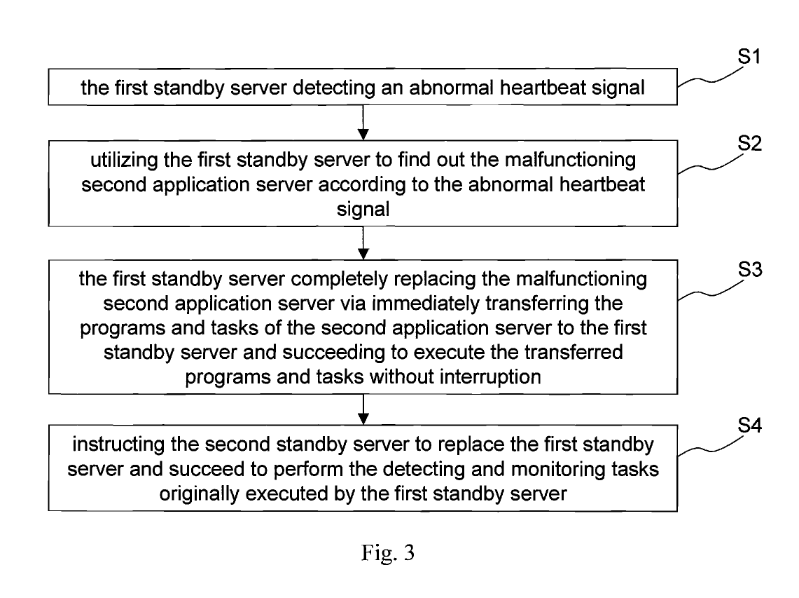

FIG. 3 is a flowchart of the failover method for the multi-agent hot-standby system shown in FIG. 2. In Step St, the first standby server 271 detects an abnormal heartbeat signal. In Step S2, the first standby server 271 finds out the malfunctioning second application server 262 according to the abnormal heartbeat signal. In Step S3, the first standby server 271 completely replaces the malfunctioning second application server 262, and the programs and tasks originally executed by the second application server 262 are immediately transferred to the first standby server 271 without interruption. In Step S4, the second standby server 272 is instructed to replace the first standby server 271 and execute the monitoring and detecting task originally executed by the first standby server 271.

Besides, the malfunctioning application server 262 can be repaired to function as a second standby server. In other words, although a standby server is used to replace a malfunctioning application server, the repaired malfunctioning application server can be used to function as a second standby server; thus, increasing malfunctioning application servers will not cause extra expenditure for compensating the quantity of the standby servers. The application servers may also connect with a load balancing system. When several identical information service demands (for example, requirements for realtime information from a same device) are sent to the application servers, one application server can send one piece of information to collaborating servers having a load balancing mechanism (such as dispatching servers). Then, the collaborating servers transmit the information to users. Thereby, the application servers can be free from overload.

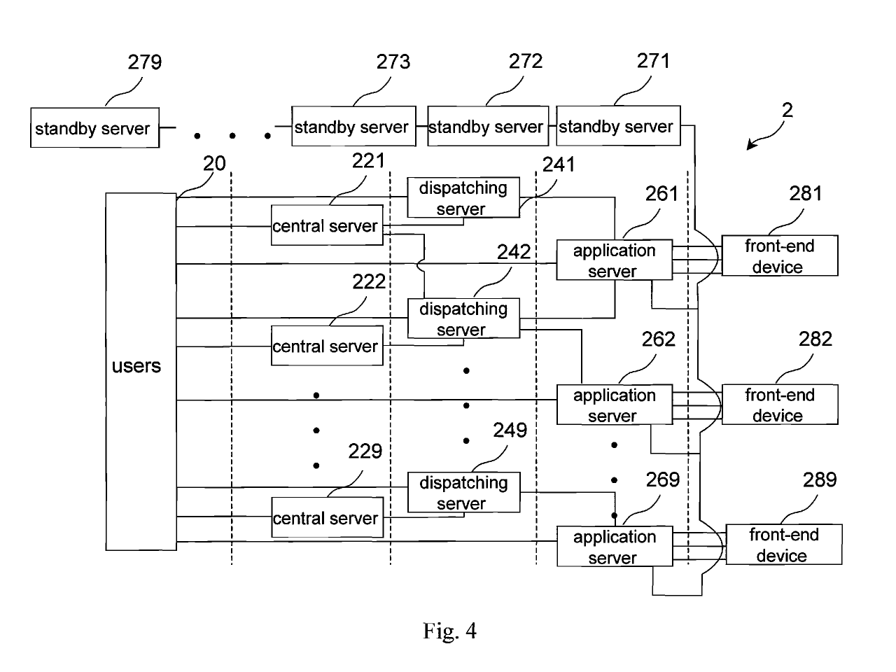

Those have been described above are only about the connection relationship between the application servers and the standby servers and the operation process thereof. Below is described a large-scale network video system adopting the multi-agent hot-standby system of the present invention. Refer to FIG. 4 a diagram schematically showing the architecture of a large-scale network video system. In this embodiment, users 20 send signals to a network video system 2 to request for video services. Via a network, the signals are transferred to a plurality of central servers 221, 222 . . . 229 and a plurality of dispatching servers 241, 242 . . . 249. By a load balancing cluster mode, service-demanding signals are averagely distributed to the central servers 221, 222 . . . 229 or the dispatching servers 241, 242 . . . 249. On the other side, N application servers 261, 262, 263, 264 . . . 269 are respectively coupled to corresponding front-end devices 281, 282 . . . 289. The application servers 261, 262, 263, 264 . . . 269 simultaneously receive service-demanding signals from the users 20 and the dispatching servers 241, 242 . . . 249 and turn on or drive corresponding front-end devices 281, 282 . . . 289 according to the service-demanding signals. All the application servers 261, 262, 263, 264 . . . 269 are parallel connected with a standby server 271, and the standby server 271 and a plurality of standby servers 272, 273 . . . 279 are connected in series. The standby server 271, which is parallel connected with the application servers 261, 262, 263, 264 . . . 269, determines whether they are normal via receiving their heartbeat signals and monitoring them. Once the application server 262 generates an abnormal heartbeat signal, the standby server 271, which is connected with the application servers 261, 262, 263, 264 . . . 269, immediately takes over the instruction set of the malfunctioning application server 262 and replaces the malfunctioning application server 262 to continues the execution of the programs and tasks originally executed in the malfunctioning application server 262 without interruption. While performing instruction set for playing the role originally performed by the malfunctioning application server 262, the standby server 271 becomes heartbeat signal abnormal to another standby server 272 cascaded thereto, and the standby server 272 immediately takes over the tasks of the standby server 271 to detect and monitor all the application servers 261, 262, 263, 264 . . . 269, wherein the application server 262 has been replaced by the standby server 271. At the same time, a standby server 273 cascaded to the standby server 272 succeeds to monitor the standby server 272. In addition to the load balancing cluster mode, the central servers 221, 222 . . . 229 and the dispatching servers 241, 242 . . . 249 may also be monitored by an active/active mode.

In conclusion, the multi-agent hot-standby system and the failover method for the same of the present invention apply to a server system wherein servers cannot be selected floatingly. The present invention can effectively reduce the cost of constructing a system via cascading a plurality of standby servers and can enable a server system to tolerate more faults with less standby servers used.

Those embodiments are to exemplify the present invention to enable the persons skilled in the art to understand, make ands use the present invention. However, it is not intended to limit the scope of the present invention. Any equivalent modification or variation according to the spirit of the present invention is to be also included within the scope of the present invention.

What is claimed is:

1. A multi-agent hot-standby system comprising:
a plurality of application servers; and
a plurality of standby servers cascaded to each other, including at least one first standby server and at least one second standby server, wherein said first standby server is connected to all said application servers and monitors said application servers; once one of said application servers malfunctions, said first standby server replaces said malfunctioning application server to make all programs operate normally; said second standby server replaces said first standby server and succeeds to monitor said application servers.

2. A multi-agent hot-standby system according to claim 1, wherein said application servers communicate with said first standby server via heartbeat signals; alternatively, said first standby server actively detects whether said application servers are normal.

3. A multi-agent hot-standby system according to claim 1, wherein said application servers are used to execute a heartbeat software and application softwares.

4. A multi-agent hot-standby system according to claim 1, wherein said first standby server and said second standby server are used to execute a heartbeat software, a hot-standby administration software and application softwares.

5. A multi-agent hot-standby system according to claim 1, wherein said malfunctioning application server is repaired to function as one said second standby server.

6. A multi-agent hot-standby system according to claim 1, wherein said application servers are coupled to a load balancing server system.

7. A multi-agent hot-standby system according to claim 6, wherein said load balancing server system controls operations of said application servers according to service requests of at least one user.

8. A multi-agent hot-standby system according to claim 1, wherein said application servers are coupled to a plurality of devices via at least one network.

9. A multi-agent hot-standby system according to claim 1, wherein said first standby server one-to-one monitors said application servers.

10. A multi-agent hot-standby system according to claim 1, wherein said first standby server one-to-many monitors said application servers.

11. A multi-agent hot-standby system according to claim 1, wherein said second standby server monitors said first standby server.

12. A failover method for a multi-agent hot-standby system comprising following steps:
detecting an abnormal heartbeat signal;
utilizing at least one first standby server to find out a malfunctioning application server according to said abnormal heartbeat signal;
said first standby server completely taking over tasks of said malfunctioning application server; and
instructing at least one second standby server to replace said first standby server and succeed to perform monitoring tasks.

13. A failover method for a multi-agent hot-standby system according to claim 12, wherein conditions under detecting said abnormal heartbeat signal include that no heartbeat signal is detected.

14. A failover method for a multi-agent hot-standby system according to claim 12, wherein methods for said first standby server to completely take over tasks of said malfunctioning application server are realized via that said first standby server performs an instruction set for replacing said malfunction application server.

15. A fault-tolerant method for a multi-agent hot-standby system according to claim 14, wherein methods for said first standby server to completely take over tasks of said malfunctioning application server are realized via executing an instruction set in said first standby server for replacing said malfunction application server, and the methods for exchanging said instruction are realized via exchanging a heartbeat software, application softwares, databases, IP (Internet Protocol) addresses and network settings.

16. A failover method for a multi-agent hot-standby system according to claim 12 further comprising a step of repairing said malfunctioning application server after utilizing at least one standby server to find out a malfunctioning application server according to said abnormal heartbeat signal.

17. A failover method for a multi-agent hot-standby system according to claim 16, wherein after said step of repairing said malfunctioning application server, repaired said malfunctioning application server is used to perform hot-standby monitoring.
